(19) United States
(12) Patent Application Publication
(10) Pub. No.: US 2003/0234150 A1
(43) Pub. Date: Dec. 25, 2003

(54) Clutch disk arrangement for a multiple-disk clutch

(75) Inventors: Andreas Orlamunder, Schweinfurt (DE); Sebastian Vogt, Bad Neustadt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/465,079

(22) Filed: Jun. 19, 2003

(30) Foreign Application Priority Data
Jun. 19, 2002 (DE) 102 27 265.4

(51) Int. Cl. F16D 13/64

(52) U.S. Cl. 192/70.19; 192/206

(57) ABSTRACT

A clutch disk arrangement for a multiple-disk clutch includes at least two friction lining units, a hub element which is connectable to or is connected to the shaft so as to be fixed with respect to rotation and a support arrangement to which the friction lining units are connected substantially so as to be fixed with respect to rotation and by which the friction lining units are connected to or connectable to the hub element. The support arrangement includes a first support member which is connected to or connectable to the hub element and to which one of the friction lining units is fixedly connected, and at least one other support member to which at least one other respective friction lining unit is fixedly connected. The other support members are directly or indirectly connected to the first support member so as to be fixed with respect to rotation relative to it, but axially displaceable relative to the first support member.

### BACKGROUND OF THE INVENTION

1. Field of the Invention

The invention is directed to a clutch disk arrangement for a multiple-disk clutch comprising at least two friction lining units, a hub element which is connectable to or is connected to the shaft so as to be fixed with respect to rotation relative to it, a support arrangement to which the friction lining units are connected substantially so as to be fixed with respect to rotation relative to it and by which the friction lining units are connected to or connectable to the hub element.

2. Description of the Related Art

Clutch disks of the type which contains two coaxial parts that are arranged so as to be rotatable in relation to one another against flexible elements acting at the circumference are already known from U.S. Pat. No. 4,892,177. The support of the movable friction disk is arranged axially between two flanges, its axial movability being permanently defined at least by the two flanges.

An arrangement of the type mentioned above is very inflexible with respect to adapting to the torque that can be transmitted and requires comparatively extensive release play because the parallel guiding of the two clutch disks relative to one another can not be ensured in an optimal manner.

### SUMMARY OF THE INVENTION

Therefore, it is the object of the present invention to provide a clutch disk arrangement which can be adapted in a simple manner to the altered construction spaces and different requirements of torque transmission capability and also to provide a guiding of the friction lining units relative to one another in an economical construction.

According to the invention, the support arrangement comprises a first support member which is connected to or connectable to the hub element and to which one of the friction lining units is fixedly connected and comprises at least one other support member to which at least one other respective friction lining unit is fixedly connected. The other support members are directly or indirectly connected to the first support member so as to be fixed with respect to rotation relative to it, but axially displaceable relative to the first support member. In this connection, it is advantageous that the clutch disk arrangement can transmit a higher torque and that the production costs remain favorable without the need for increasing the outer diameter.

According to another feature, it can be advantageous when at least two other support members are provided which are connected to the first support member. Also, it is possible to arrange the other support members axially on both sides of the first support member. This makes it possible to improve the performance of the clutch disk arrangement and to make use of the construction space in axial direction and also makes possible a symmetric introduction of force with respect to the flange of the hub element.

The object can also be met by a support arrangement having at least one support member which is connectable or connected to the hub element and to which at least one friction lining unit is fixedly connected by at least one support plate in an operative connection with the friction linings. This allows a clutch disk arrangement to be produced in a particularly economical manner without forfeiting the known advantages of conventional clutch disks and decoupling the support member with respect to axial vibrations of the friction lining units.

Particularly economical results are achieved when the clutch disk arrangement is expandable in modular manner with friction lining units and the support member is connected, if desired, to a plurality of friction lining units by support plates in operative connection with the friction linings.

The engagement process becomes particularly simple when the friction lining units are axially compressible or, alternatively, when they are constructed in multiple layers. The multiple layers of the friction lining unit can have different friction materials. This makes it possible to specifically adapt the clutch unit to the intended use and the projected useful life.

The friction lining units can have a lining suspension in a particularly simple manner. This lining suspension can be constructed in one part or combined with the support plates and makes possible a deliberate dissipation of heat occurring as a result of friction.

When using a plurality of friction lining units in axial direction, it is often sufficient when some of the friction lining units have a lining suspension. In this respect, it is particularly advantageous when the friction lining unit located closest to the flywheel axially has a lining suspension or, if desired, the friction lining unit located closest to the diaphragm spring axially has a lining suspension. Particularly at the start of the engagement process, this results in an especially smooth engagement and gradual increase in torque.

The engagement behavior can be designed in a particularly advantageous manner when the lining suspensions of the respective friction lining units have different rigidity. In this connection, the spring travel or spring path of the lining suspensions can also be carried out differently and the interruption of torque transmission in the disengaged state is accordingly ensured with small release play.

It can also be advantageous when the lining suspension of a friction lining unit is constructed differently. It can be particularly advantageous when the lining suspension has areas of different lining suspension rigidity in circumferential direction or the lining suspension has areas with different lining spring paths in circumferential direction. This has a particularly advantageous influence on the clutch release behavior and the drag torque in the disengaged state.

It can also be advantageous when the lining suspension has areas of different lining suspension rigidity in radial direction or the lining suspension has areas with different lining suspension paths in radial direction. This makes it possible to influence the engagement behavior deliberately and, in particular, to increase the transmitted torque during engagement. The temperature behavior of the friction lining units can be influenced in a particularly advantageous manner in the disengaged state when the friction lining unit has different expansion in axial direction in the unloaded state.

A clutch disk arrangement can be designed in a particularly economical manner when the friction lining unit is connected to the support member by means of support plates or, in cases where the friction lining unit has a lining suspension, the friction lining unit is connected to the support member by lining suspension plates. The production process can be further simplified when another support member is fixedly connected to a plurality of friction lining units. These friction lining units can then be arranged at the support member with the same fastening means in a single operation. Alternatively, it is also possible for a plurality of friction lining units to be allocated to at least one support member by means of support plates. These support plates can be constructed, if desired, with lining suspensions that differ from one another.

The adaptability of the clutch disk arrangement to high torque can be designed in a particularly simple manner when the first support member has connection pins by which at least one other support member can be allocated. A corresponding advantage can also be achieved when a second support member has connection pins which can be allocated to the first support member. For particularly high torques and, at the same time, economical manufacture, it is advantageous when connection pins are allocated to the first support member, by means of which connection pins additional support members can be allocated.

In this connection, assembly of the clutch unit can be made particularly simple when the connection pins extend primarily axially. The torque flow is positively influenced when the connection pins secure the additional support member in circumferential direction. In particular, this has an influence on behavior when changing from pull operation to push operation. The connection pins can center the second support member in radial direction so that an especially quiet operation is achieved.

The drag torque in the disengaged state can accordingly be reduced when the second support member is displaceable at least to a limited extent in axial direction relative to the connection pins. Forces occurring in this connection which act on the connection pins in axial direction can be contained in a particularly simple manner when the connection pins are axially fixedly connected to the first support member or to the hub flange.

The guiding of the first support member or of the other support members relative to the hub is particularly reliable when the other support member engages in a positive engagement with the connection pins. The support member can have axially extending openings for cooperating with the connection pins. The manufacturing costs and the multiplicity of component parts can be reduced when the support member has radially offset axial openings for engaging with connection pins of a first support member and of a second support member.

The axial openings can be introduced by means of a punching tool in a particularly simple manner when the axial openings open radially inward. The quantity of different components can be reduced in a particularly simple manner when the axial openings for allocation of additional support members by the connection pins are offset relative to one another in circumferential direction.

In order to ensure a reliable functioning of the clutch unit in continuous operation, the connection pins can be provided with one or more axial retaining elements. The axial retaining elements can grip around the connection pins at least partly. These axial retaining elements can be immovable relative to the corresponding connection pins, but in particular cases the axial retaining elements can also be constructed so as to be axially movable to a limited extent relative to the connection pins. This ensures that the respective support members are exactly positioned relative to one another and accordingly provides for a reproducible behavior also when axial vibrations occur.

The position of the hub and support members relative to one another is accordingly reliably ensured in that the axial retaining elements limit the axial displacement of the support members. Due to the fact that the axial retaining elements are constructed so as to be compressible, the installation of pneumatic springs can be omitted without having to tolerate increased drag torque. The load limit for the transmission of torque via the connection pins can be increased when the axial retaining elements secure the connection pins in circumferential direction. However, it is also possible that the axial retaining elements secure the connection pins radially in order to prevent centrifugal force effects.

When the connection pins have, at least in part, regions in their end portions which limit axial displacement of a support member relative to the connection pins, the clutch unit can be preassembled as a clutch module and requires no special steps for securing during transport.

In order to be able to contain torque shocks in the drivetrain of the motor vehicle, it may be advantageous when a limited relative rotation is made possible between the hub element and the friction lining units. At uniform rotational speeds, it is advantageous to compress energy accumulators through this relative rotation; the energy accumulators act between the hub element and friction lining units. The energy accumulators are constructed as spring elements in order to achieve long-lasting operation.

Friction is preferably generated during relative rotation in order to damp occurring oscillation amplitudes.

The axial displacement of a support member relative to the connection pins can be limited in a particularly economical manner when the area is formed as an upsetting or thickening or when the area is formed by applying material.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a longitudinal section through a clutch arrangement for a multiple-disk clutch according to the prior art.

FIG. 2 shows a partial longitudinal sectional view of a clutch disk arrangement according to the invention.

FIG. 3 is a partial axial view of the clutch disk arrangement according to the invention from FIG. 2.

FIG. 4 is a longitudinal sectional view through another clutch disk arrangement according top the invention.

FIG. 5 is a partial axial view of the clutch disk arrangement according to FIG. 4.

FIG. 6 is a longitudinal sectional view through another clutch disk arrangement according to the invention.

FIG. 7 is a partial axial view of the clutch disk arrangement according to FIG. 6.

FIG. 8 is a longitudinal sectional view through another construction of a clutch disk arrangement according to the invention.

FIG. 9 is a partial axial view of the clutch disk arrangement according to FIG. 8.

FIG. 10 shows a construction of an axial guide according to the invention.

FIGS. 11 to 15 show contours of a possible construction of the cross section of the connection pins.

FIG. 16 is a longitudinal sectional view through another construction of a clutch disk arrangement according to the invention.

FIG. 17 shows a partial axial view of the clutch disk arrangement according to FIG. 16.

FIG. 18 is a longitudinal sectional view through another embodiment form of a clutch disk arrangement according to the invention.

FIG. 19 shows a partial axial view through the clutch disk arrangement according to FIG. 18.

### DETAILED DESCRIPTION OF THE PRESENTLY PREFERRED EMBODIMENTS

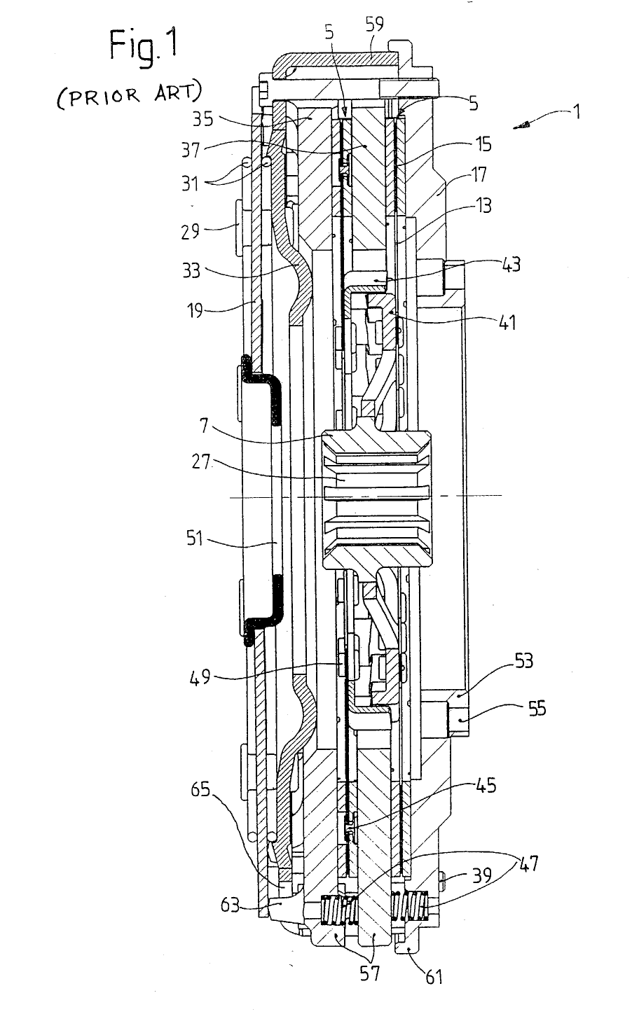

In FIG. 1, a clutch unit 1 can be used for the clutch disk arrangement according to the invention. Considered in axial direction, it preferably comprises the diaphragm spring 19 arranged outside of the clutch housing 33, the clutch housing 33, a pressing plate 35, the intermediate plate 37 and the clutch disk which is constructed in this case in a two-disk version; following in axial direction is the flywheel 17 which is connected with the clutch housing 33.

The diaphragm spring 19 is fastened to the housing by the wire rings which are formed as bearing point and fulcrum and by the diaphragm spring bearing pins 29 which are distributed in circumferential direction along these wire rings 31 such that the diaphragm spring bearing pins 29 penetrate the diaphragm spring 19 in the area of transition between the tongue portion and spring portion located in radial direction. These diaphragm spring bearing pins 29 are fastened, advantageously riveted, by one end portion in the clutch housing 33. In this way, by their head area located at the other axial end, these diaphragm spring bearing pins 29 secure the wire rings 31 which accordingly position the diaphragm spring 19 in axial direction. The positioning of the diaphragm spring 19 in circumferential and radial direction is carried out in a manner known per se by means of the diaphragm spring bearing pins 29 mentioned above.

At the radial inner end of the diaphragm spring tongues, there is a sleeve-like actuation receptacle 51 by which a clutch release bearing or clutch release cylinder can act on the diaphragm spring tongues and accordingly on the diaphragm spring 19. Further, the clutch unit 1 comprises the pressing plate 35 located inside the clutch housing 33 and, following this in axial direction, the intermediate plate 37. Both the pressing plate 35 and the intermediate plate 37 have, at their radial outer end areas, retaining lugs 57 which are constructed as radially extending brackets and which engage in complementary radially directed openings in the clutch housing 33. These complementary housing openings are formed by the abutment areas 59 which extend axially in the shape of strips or brackets. Further, on its side facing the diaphragm spring, the pressing plate 35 has a supporting projection 63 which extends in circumferential direction and cooperates with the spring area of the diaphragm spring 19. The supporting projection 63 is interrupted repeatedly in circumferential direction, and its end area on the side of the diaphragm spring penetrates through the through-openings 65 arranged successively in circumferential direction. The axially extending abutment areas 59 contact the contact face of the flywheel 17 by their end areas remote of the diaphragm spring. The clutch housing 33 is positioned at the flywheel 17 by the housing centering rim 61 for rotating jointly with the latter.

Further, the clutch housing 33 is fastened to the flywheel 17 by the connection screws 39. These connection screws 39 penetrate the clutch housing 33 in the zones of the abutment areas 59, so that there is no collision with the retaining lugs 57 of the pressing plate 35 and intermediate plate 37.

In the area of the retaining lugs 57, axially acting force accumulators acting as clutch release springs 47 are located axially between the pressing plate 35 and intermediate plate 37 and the intermediate plate 37 and flywheel 17. These release springs 47 which are constructed as helical pressure springs are recessed into pocket bore holes of the respective structural component parts so as to be permanently positioned.

The pressing plate 35 has a centering collar 53 at in its engine-side area for engaging in corresponding counter-surfaces at the crankshaft. The fastening of the flywheel 17 to the crankshaft is carried out by screws which engage through the fastening openings 55.

Since the fastening openings 55 continue from the flywheel 17 in axial direction through the entire clutch unit, it is possible to mount the clutch unit 1 in the preassembled state as is shown in the drawing and fasten it to the crankshaft as a preassembled clutch module. The required orientation of the clutch module relative to the crankshaft is carried out by means of the axial and radial surface regions of the centering collar 53. Subsequently, corresponding fastening screws are inserted through the clutch unit into the fastening openings 55 and the clutch module is screwed together with the crankshaft.

The clutch unit 1 further shows a hub element 7 with an inner teeth 27 for engaging with a driven shaft. The hub element 7 is connected to a base element 41 in the radial outer area. In its outer radially extending surface region, this base element 41 is connected by rivets or screws to a support plate 13 which carries a friction lining unit 5 on the radial outer side. Further, the base element 41 has axially extending teeth which cooperate with complementary teeth of a cup-shaped member 43, resulting in a non-rotational but axially displaceable connection. The cup-shaped member 43 is likewise connected in a radial extension area to a support plate 13 which has another friction lining unit 5 on the radial outer side.

The friction lining units are connected to the support plate 13 by lining rivets in each instance. The clutch unit 1 operates in the following manner:

The diaphragm spring 19 is pivotably mounted at the wire rings 31. The spring area of the diaphragm spring 19 extends outward in radial direction from the wire rings 31 up to the support region on the supporting projection 63 of the pressing plate 35. Since the diaphragm spring 19 is mounted outside the clutch housing 33, the supporting projections 63 of the pressing plate extend through the through-openings 65 of the clutch housing 33. The force is exerted by the pressing plate 35 in the direction of the flywheel 17. In this case, the pressing plate 33 is supported at the release springs 47 close to the pressing plate which are distributed along the circumference and at the friction lining unit 5 which is riveted to the cup-shaped member 43 by support plates 13. Both the friction lining unit mentioned above and the release spring 47 close to the pressing plate conduct the force of the diaphragm spring 19 farther to the intermediate plate 37 in direction of the flywheel 17. Since the intermediate plate 37 and the pressing plate 35 are supported by means of retaining lugs 57 so as to be fixed with respect to rotation but so as to be axially displaceable relative to the clutch housing 33, the engagement force generated by the diaphragm spring is conducted farther to the release springs 47 near the flywheel and to the friction lining unit 5 near the flywheel. These latter are supported in turn at the flywheel 17.

During the engagement process, the pressing plate 35 and the intermediate plate 37 are moved toward the flywheel 17 by the force of the diaphragm spring 19, and the two friction lining units 5 are pressed on the respective friction surfaces of the pressing plate 35, intermediate plate 37 and the flywheel 17. In this connection, the friction lining unit 5 which is riveted to the cup-shaped member 43 and the friction lining unit 5 which is riveted to the base element 41 must execute an axial displacement in the direction of the flywheel 17 during the transition from the disengaged to the engaged state. The axial displacement of the friction lining unit 5 which is riveted to the cup-shaped member 43 produces a like axial displacement of the cup-shaped member 43 relative to the base element 41. In addition, there is a relative movement of the teeth in the axial overlapping area of the above-mentioned structural component parts 43 and 41. These teeth ensure the transmission of torque from the cup-shaped member 43 to the base element 41. The friction lining unit 5 which is riveted to the base element 41 occurs due to a relative movement of the hub element 7 connected to the base element 41 relative to the driven shaft which is spline-toothed with the latter.

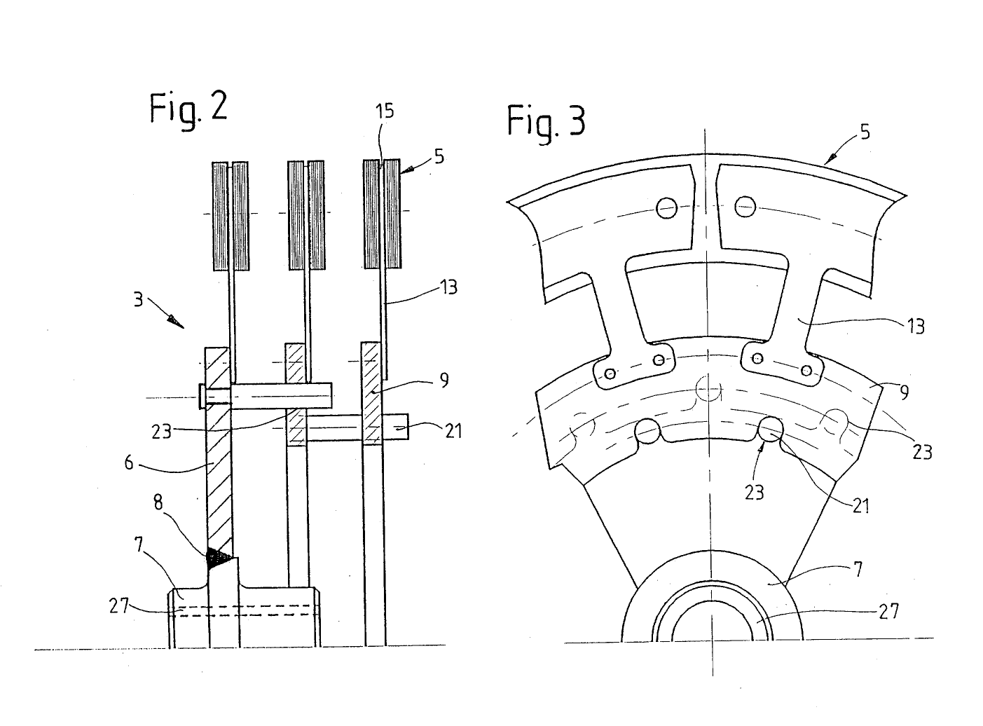

FIG. 2 shows a clutch disk, according to the invention, which is suitable for use in a clutch unit according to FIG. 1 when outfitted with an additional intermediate disk and corresponding axial extension of the clutch housing.

The clutch disk arrangement 3 in this case comprises the hub element 7 with the internal spline toothing 27 for cooperating with a driven shaft. The hub element 7 is connected to a flange 6 at the outer side by a weld 8. Possible welding methods include friction welding, laser welding or welding methods with weld filler material. In the radial outer area of the flange 6, a friction lining unit 5 is riveted to the flange 6 by support plates 13. The rivets are indicated by dash-dot lines in this sectional view. Further, the flange 6 has axially extending connection pins 21 which are suitable for receiving one or more support members 9. In this embodiment form, the connection pins 21 are fastened to the flange 6 by stepped sections which are formed on the opposite side as a rivet head. The connection shafts 21 are constructed as a cylindrical shafts which extend through axial openings 23 of an adjacent support member. The connection pins 21 riveted to the flange 6 are uniformly distributed on a reference circle or pitch circle D1 in such a way that they center the first support member 9 with respect to the axis of rotation of the hub element 7. The support member 9 is displaceable along the connection pins 21 with respect to the flange 6 and, at its radial outer area, has support plates 13 which provide another friction lining unit 5. Further, connection pins 21′ which are uniformly distributed in circumferential direction and extend in the same direction as the connection pins 21 that are riveted to the flange 6 are fastened to this first support member 9 on a pitch circle diameter D2. The connection pins 21′ fastened to the support member 9 extend through axial openings 23′ of a second support member 9′ and position this support member 9′ relative to the axis of rotation of the hub element 7. This second support member 9′ likewise has, in its radial outer area, support plates 13 connected to another friction lining unit 5. The second support member 9′ is likewise displaceable axially relative to the first support member 9 or flange 6. In order to arrange the highest possible quantity of connection pins 21, 21′ on the respective pitch circle diameter it is advantageous that the respective pitch circle diameters D1 and D2 have different diameters. In the embodiment form shown in FIGS. 2 and 3, the diameters of the respective pitch circles of the connection pins 21, 21′, fastened to the flange 6 and support member 9 diverge from one another in such a way that they do not contact in radial direction when overlapping axially. The connection pins 21, 21′ can be constructed particularly economically when they are used as pins with constant diameters. The axial openings 23 arranged in the first support member 9 are constructed as bore holes which are slightly overdimensioned with respect to the diameter of the corresponding connection pins 21. Alternatively, the axial openings 23′ introduced in the second support member 9′ can be produced as punch-outs which are open in their area facing radially inward or, alternatively, have generous tolerances so that they do not have any contact with the connection pins 21′ passing through them in this radially inner surface region. In particular, the construction with axial openings at the support member 9′ which open radially inward can be produced particularly economically by a one-piece punch of a sheet metal punching machine. As can be seen from the construction of the clutch disk according to the invention shown in FIGS. 2 and 3, it is possible to expand this clutch disk arrangement by corresponding support members 9 with friction lining units 5 that are allocated via support plates 13 such that corresponding connection pins 21 are riveted to the respective previous support member 9. Alternatively, the support member 9 and connection pins 21 can also conceivably be connected by friction welding.

The flange 6 which is outfitted with connection pins 21 can be assembled with the support member 9 via the axial openings 23 in a particularly simple manner when the connection pins 21 have an insertion aid, e.g., a bevel, at their axial end. Alternatively, it is also possible to introduce this insertion aid into the axial openings 23 of the support member 9.

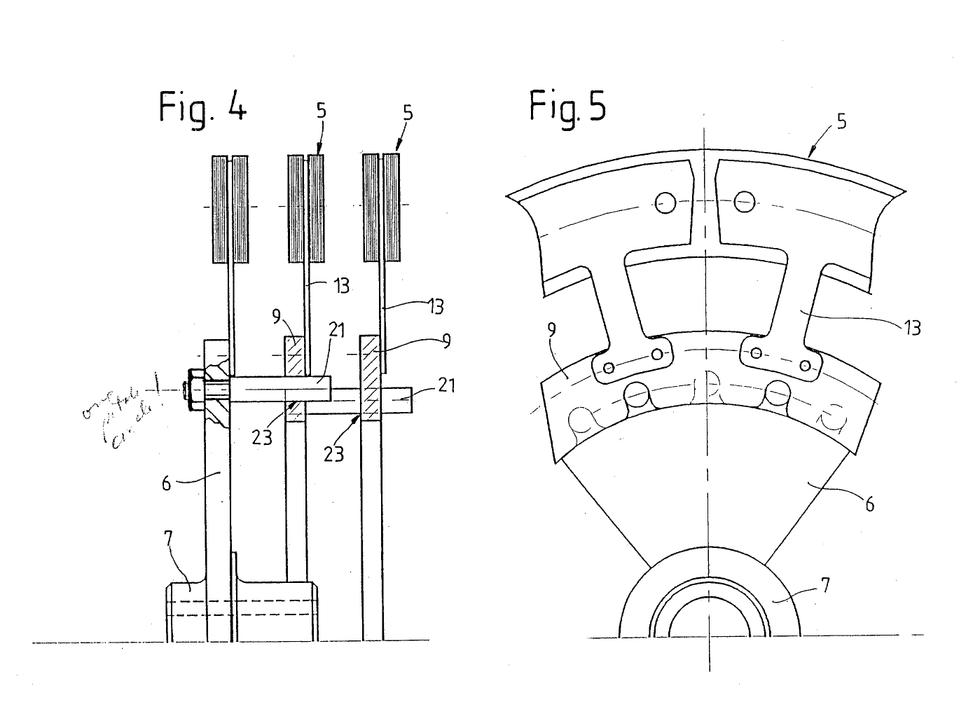

In the alternative embodiment form of a clutch disk arrangement 3 shown in FIGS. 4 and 5, the hub element 7 is produced integral with the flange 6 as a cast part. In the outer area of the flange 6 are support plates 13 which are riveted with the friction lining unit 5. Connection pins 21 which are uniformly distributed in circumferential direction are fastened to a pitch circle diameter D3 in the flange 6 in such a way that these connection pins 21 have, at their end facing the flange 6, a stepped bolt provided with an external thread. This bolt extends through the fastening opening of the flange 6 and is secured on the opposite side by a nut. The connection pins 21 fixed to the flange 6 engage in axial openings 23 of a first support member 9 in a manner similar to that shown in FIGS. 2 and 3. The axial openings of the first support member 9 are again constructed so as to open radially inward. Accordingly, the support member 9 can be produced as a punched part by an individual punch. Further, additional connection pins 21′ arranged on the pitch circle diameter D3 extend from the first support member 9 in the direction of a second support member 9′. This second support member is likewise formed with axial openings 23′ on the pitch circle diameter D3, so that the other connection pins 21′ position this second support member 9′ with respect to the axis of rotation of the hub element 7. The connection between the first support member 9 and the additional connection pins 21′ can be carried out by welding or screwing. The first connection pins can also be fastened to the flange 6 by spring rings (DIN 9045) or the like as an alternative to screws. In the embodiment form according to FIGS. 4 and 5, the first connection pins 21 and the additional connection pins 21′ are arranged on the same pitch circle diameter D3. Therefore, it is necessary that the respective connection pins 21 which are fastened to the flange 6 are arranged so as to be offset in circumferential direction relative to the other connection pins 21′ which are fastened to the first support member 9. In a particularly economical and simple embodiment form, the connection pins 21′ can be arranged on the pitch circle diameter D3 so as to be uniformly distributed in circumferential direction with a pitch N and the axial openings 23 in the support member 9 are likewise arranged on the pitch circle diameter D3 so as to be uniformly distributed in circumferential direction with pitch N. With these support members 9 on which connection pins 21′ are arranged and axial openings 23 are provided, the axial openings 23 are arranged so as to be offset in circumferential direction with respect to the connection pins 21′ arranged on the first support members 9. It is particularly advantageous when they are arranged so as to be offset by ½×N. In this way, a clutch disk arrangement 3 according to the invention can be expanded economically, if required, with additional support members 9, each having an additional friction lining unit 5 via support plates 13.

Since the torque to be transmitted via the connection pins 21, 21′ increases in a clutch disk arrangement 3 of this type proceeding from the support member 9′ farthest from the flange 6 with support plates 13 and friction lining unit 5. With each additional friction lining unit 5, it can be advantageous when the quantity of connection pins 21, 21′ matches the respective torque to be transmitted. This can be achieved, for example, in an embodiment of a clutch disk arrangement 3 according to FIG. 4 in that the quantity of connection pins 21′ between the support arrangement 9 farthest from the flange 6 axially and the support member 9′ following axially in the direction of the flange 6 corresponds to a whole-number multiple of the number Z and the quantity of connection pins 21 between the following support member 9 and the flange 6 fits the quantity of two-times Z. A further possibility consists in that the quantity of connection pins 21′ between a final support member 9′, that is, the support member 9′ farthest axially from the flange 6, and the respective additional support member following the flange 6 in axial direction corresponds to the number Z. The quantity of friction lining units 5 fastened to the final support member 9′ is designated by A and the quantity of friction lining units fastened to the following support member 9′ is designated by B. Consequently, for the quantity X of additional connection pins 21 to an additional support member 9: X=(A+B)/A×Z. However, it is also conceivable for the connection pins 21 to be distributed in a manner which diverges from the preceding examples.

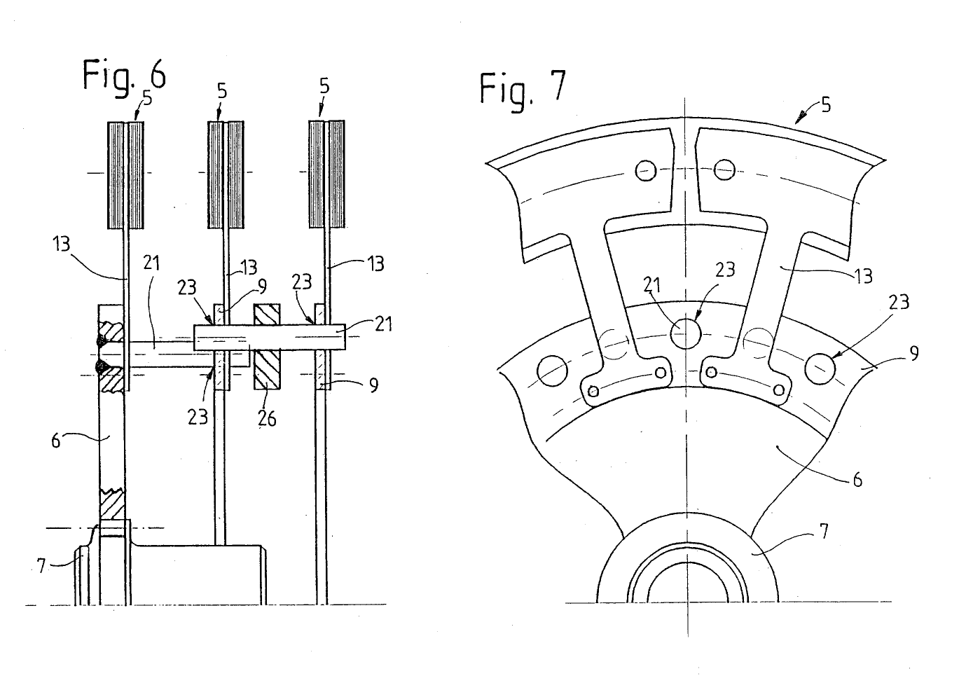

According to another construction of clutch disk arrangement 3 according to the invention shown in FIGS. 6 and 7, the flange 6 can be connected in a positive engagement to external teeth of the hub element 7 by internal teeth. This connection can be constructed so as to be detachable or not detachable. At its radial outer area, the flange 6 has support plates 13 which are riveted to it and which are connected to a friction lining unit 5. Further, first connection pins 21 extending in axial direction are fastened to the flange 6 at one of their axial ends by means of a weld connection. The first connection pins 21 extend through axial openings 23 of a first support member 9 which is accordingly fixed radially and in circumferential direction relative to the flange 6 but is axially displaceable relative to the latter. Like the flange 6, the first support member 9 is connected with support plates 13 having an additional friction lining unit 5 in their radial outer areas. In contrast to the preceding embodiment forms, the first support member 9 has additional axial openings 23 which are penetrated by a second arrangement of connection pins 21′. At their other axial end, these second connection pins 21′ penetrate a second support member 9′ having axial openings 23′ which correspond to it. The second support member 9 differs from the first support member 9 only by the different quantity of axial 23′ for cooperating with connection pins 21′. Although the first and second connection pins 21, 21′ are arranged on the same diameter D4 in this embodiment form, as shown in FIG. 7, it is conceivable for them to be arranged on pitch circles which deviate from one another. Spacers 26 engage around the second connection pins 21′. These spacers 26 can carry out several tasks simultaneously. Due to the fact that each spacer 26 engages around several of the second connection pins 21 extending in circumferential direction, these engaged connection pins 21′ can be supported relative to one another by the spacers 26. When the spacers 26 extend in circumferential direction over more than two connection pins 21′, the latter are provided with a particularly great rigidity relative to the torque to be transmitted. This rigidity is especially high when the spacers 26 extend over all connection pins 21′ on a circle as a closed structural component part and engages around these connection pins 21′ in a positive engagement. The stiffening effect is achieved particularly by the exactly fitting contact between the spacers 26 and the respective connection pins 21′. It is particularly advantageous in this connection when the spacers 26 themselves are produced from a material with a particularly high rigidity and, if desired, are expanded in axial direction over approximately the width of the intermediate plate 37. Suitable materials with high rigidity are aluminum or iron alloys or also ceramic materials, for example. When the spacers 26 are expanded axially over approximately the total width of the intermediate plate 37, it can be advantageous when there are openings for the additional connection pins 21′ not connected to the spacers 26 so as to prevent a collision during engagement or when in the engaged state. Further, it can be advantageous to construct the spacers 26 in multiple layers in axial direction. A stiff portion can be provided which fixedly engages around the corresponding connection pins 21′ and which has, following this in axial direction, an additional material area with low spring rigidity similar to a foamed material or rubber-like element. This can be pretensioned in axial direction in the engaged state when the respective friction lining units occupy their closest position to one another axially by resting against the adjacent support members 9. In a subsequent disengagement process, the spacers 26 which are compressed in axial direction will displace the contacting support member 9 in axial direction. This characteristic of the spacers 26 ensures that the friction lining units 5 will be lifted from the respective contact faces at the pressing plate 35 or intermediate plate 37. This is particularly advantageous in a clutch disk arrangement 3 when spacers 26 having the properties mentioned above are arranged between every pair of friction lining units 5.

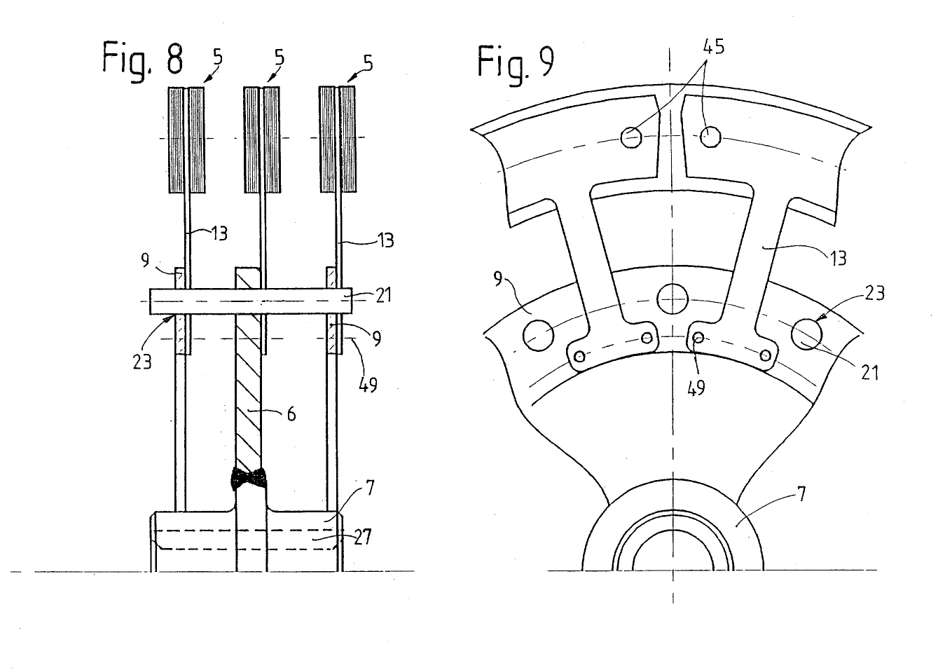

The construction of a clutch disk arrangement according to FIGS. 8 and 9 again shows a hub element 7 with a flange 6 arranged approximately in the center. This flange 6 again has, in its radial outer area, axially extending connection pins 21 which are held in their fastening area in the flange 6 by a press fit. The press fit can be produced in a particularly economical manner when the connection pins 21 have a slightly greater diameter in the area of overlap with the flange 6 than in the rest of their axial extension area. The connection pins 21 shown in this embodiment example extend on both sides of the flange 6 and can cooperate on each side with one or more support members 9. It is advantageous in this embodiment form that a plurality of support members 9 can be connected to the hub element 7 so as to be fixed with respect to rotation relative to it by these connection pins 21 by means of an arrangement of support members 9 and torque can successfully be introduced in the flange 6 symmetrically at the same time with a corresponding arrangement of the support members 9. The arrangement of the connection pins 21 which are distributed in circumferential direction need not be carried out on an individual pitch circle diameter, but rather need only be constructed in a complementary manner with respect to the axial openings 23 of the support members 9. This allows a particularly economical production of the support members 9 and of the flange 6 when the same punch or the same tool is used to produce the axial openings 23 by means of punching. In this embodiment example, the support plates 13 are fastened to the respective support member 9 via rivet bolts 49 radially inside the bearings of the connection pins 21 in order to keep down the loading for the connection pins 21 due to the torque via the friction lining units 5. Accordingly, the area pressing between the contact areas of the axial openings 23 and the connection pins 21 can be kept low and the risk of tilting is reduced.

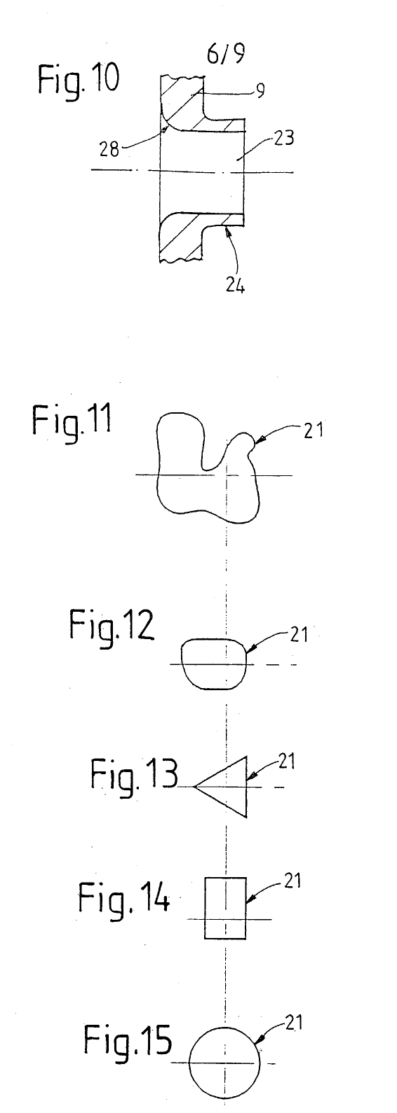

In order to prevent possible tilting of the support members 9 during axial displacement with respect to the connection pins 21, it can be advantageous when the axial openings 23 are produced from sheet metal by a punching process in such a way that—as is shown in FIG. 10—a punch indentation which can be used as an insertion aid 28 is formed on the entry side of the punching tool and forms an overhang or projecting area on the exit side through the yield of the workpiece, which projecting area increases the supporting surface between the axial opening 23 of the support member 9 and connection pins 21. Forming the projecting area 24 requires suitably adapted punching tools with platens and can be correspondingly influenced in this way with respect to shape and size. It is also possible to apply the aforementioned construction of the axial opening 23 described in FIG. 10 in the fastening area of the flange 6 with the connection pins 21.

FIGS. 11 to 15 show variations of the cross sections for the connection pins 21 which can be adapted depending on the type of loading with respect to the section or profile. The use of continuous cast material has proven economical.

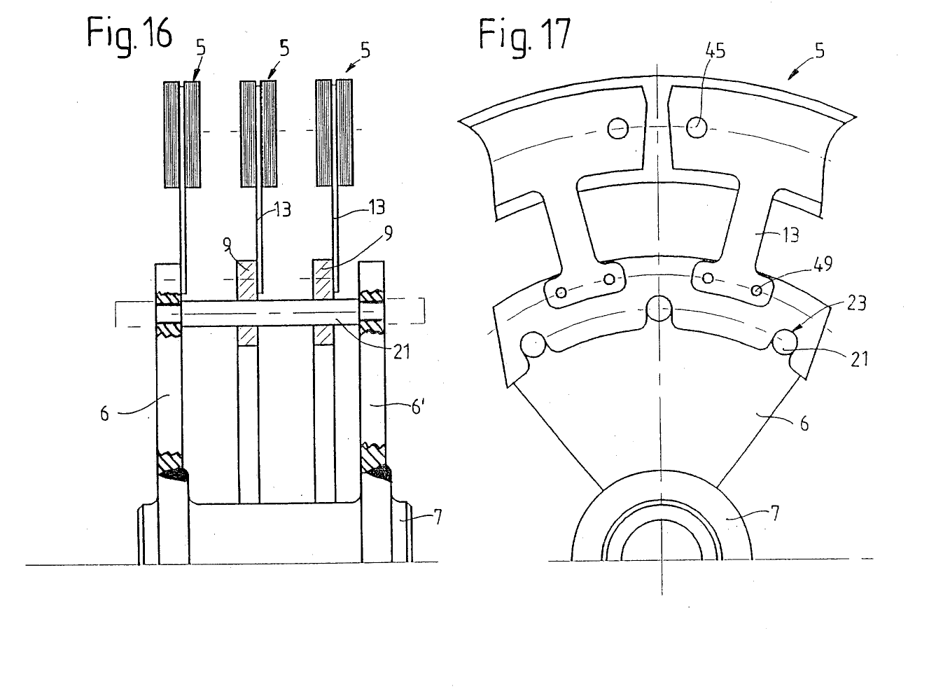

Another embodiment form of a clutch disk arrangement 3, according to the invention, is shown in FIGS. 16 and 17 and is characterized in that especially high torque can be transmitted. The hub element 7 has a flange 6 which is fixedly welded to this hub element. In a radial outer area, connection pins 21 are distributed in circumferential direction and can be connected to the flange 6 as is shown in the preceding embodiment examples. Only welding or fastening by means of retaining washers is mentioned in this connection. The flange 6 likewise has support plates 13 which are connected with a friction lining unit 5. As in the preceding examples, support members 9 are in an operative connection with support plates 13 having friction lining units 5 in the axial extension area of the connection pins 21. Another flange 6′ which is likewise engaged with the connection pins 21 and is connected in the radial inner area to the hub element 7 is arranged at the ends of the connection pins 21 axially remote of the flange 6. As is indicated by the dashed lines in a continuation of the connection pins 21, the latter can also extend beyond the respective flange areas 6 and 6′ and additional support members 9 connected to support plates 13 having friction lining units 5. The advantage of this embodiment form is that the capability of the clutch disk arrangement 3 to transmit torque is increased even further.

However, a disadvantage of this embodiment form is that the clutch disk arrangement must be prepared with the intermediate plate 37 of the clutch unit 1 in the preassembled state together with the respective intermediate friction lining units 5. It is also possible for the flange 6′ to be joined with the connection pins 21 and the hub element 7 only toward the end of this assembly. Therefore, the connection between the flange 6 and the hub element 7 can also be carried out by laser welding or riveting or by a pressing connection. However, the clutch disk arrangement 3 according to the embodiment form shown in FIGS. 16 and 17 is characterized by its capability of transmitting very high torques while at the same time having low weight and moment of inertia.

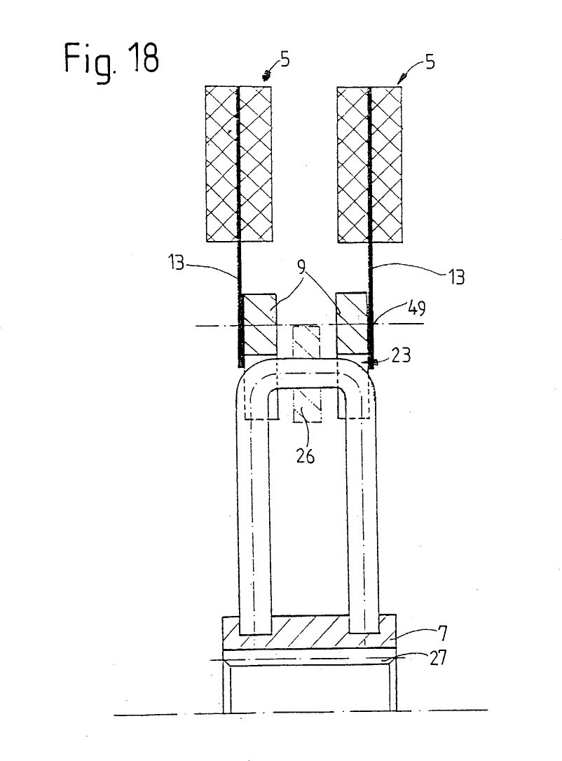

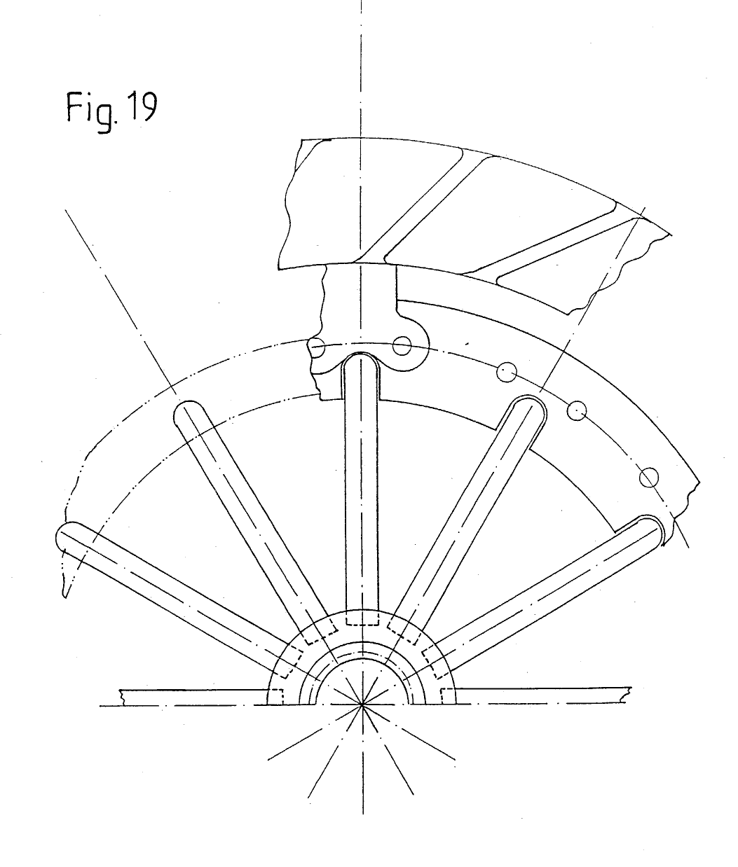

FIGS. 18 and 19 show another alternative embodiment form of a clutch disk arrangement 3 according to the invention. As in the preceding examples, it is provided with support members 9 which are connected to support plates 13 having friction lining units 5. The axial openings 23 of the support members 9 advantageously open radially inward. The support members 9 are again positioned in circumferential direction and radial direction with respect to the hub element 7 by means of the connection pins 21. In contrast to the preceding embodiment forms, however, the connection pins 21 are not fastened directly to a flange, but are connected directly to the hub element 7. The fit of the connection pins 21 in the hub element 7 can be carried out by means of a press fit, soldering or welding, advantageously by electron beam welding, laser welding or resistance welding. The extension of the axial portion of the connection pins 21 can be varied depending on the quantity of the support members 9. It is possible to introduce spacers 26 in this axial extension portion. In order to facilitate the assembly of these spacers 26, the latter are advantageously constructed in multiple parts and not assembled until mounting with the connection pins 21. The manufacturing methods mentioned above are also suitable for this purpose. If desired, a fixed connection can also be carried out in the area of contact between the spacers 26 and connection pins 21. In this case, the spacers 26 act as a stiffening element for the connection pins 21 and increase the torque transmitting capability and stiffness of the clutch disk arrangement 3. However, when the area of contact between the spacers 26 and the connection pins 21 is constructed so as to be movable or, alternatively, the spacers 26 can be compressed in circumferential direction, the connection pins 21 can be constructed so as to be flexible in such a way that they can contain torque shocks through deformation. In this case, it is particularly advantageous when the axial openings 23 of the support members 9 are constructed so as to open radially inward in order to enable a displacement between connection pins 21 and support members 9 in radial direction.

The quantity of connection pins 21 can be varied as desired depending on the torque to be transmitted. Also, it is not necessary that the connection pins 21 are arranged at uniformly distributed angular degrees relative to one another or that their axial extension area lies on the same pitch circle.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch disk arrangement comprising:
a hub element;
a first support member connected to said hub element;
at least one additional support member which is fixed against rotation relative to said first support member but axially movable relative to said first support member; and
a friction lining unit fixed to each of said support members.

2. A clutch disk arrangement as in claim 1 comprising at least two said additional support members.

3. A clutch disk arrangement as in claim 2 wherein said other support members are arranged on either side of said first support member.

4. A clutch disk arrangement as in claim 1 wherein each said friction lining unit comprises a support plate carrying at least one friction lining, each said support plate being operatively connected to a respective said support member.

5. A clutch disk arrangement as in claim 1 wherein said additional support members are added in a modular manner.

6. A clutch disk arrangement as in claim 4 comprising a plurality of said support plates connected to each of said support members.

7. A clutch disk arrangement as in claim 1 further comprising connection pins for fixing said at least one additional support member against rotation relative to said first support member.

8. A clutch disk arrangement as in claim 7 wherein said connection pins are fixed to said first support member.

9. A clutch disk arrangement as in claim 7 wherein said connection pins extend axially.

10. A clutch disk arrangement as in claim 7 wherein said connection pins secure said at least one additional support member circumferentially relative to said first support member.

11. A clutch disk arrangement as in claim 7 wherein said connection pins secure said at least one additional support member radially relative to said first support member.

12. A clutch disk arrangement as in claim 7 wherein said at least one additional support member is displaceable to a limited extent relative to said first support member.

13. A clutch disk arrangement as in claim 7 wherein at least one of said support members has axially extending openings for receiving respective said connection pins therethrough.

14. A clutch disk arrangement as in claim 13 wherein some of said openings in one of said support members are radially offset from other of said openings in said one of said support members, said some of said openings and said other of said openings receiving connection pins fixed to different said support members.

15. A clutch disk arrangement as in claim 13 wherein said axial openings open radially inward.

16. A clutch disk arrangement as in claim 14 wherein wherein said some of said openings are circumferentially offset from said other of said openings.

17. A clutch disk arrangement as in claim 7 further comprising axial retaining elements fixed to respective said connection pins.

18. A clutch disk arrangement as in claim 17 wherein said retaining elements engage at least partly around respective said connection pins.

19. A clutch disk arrangement as in claim 17 wherein said axial retaining elements are movable to a limited axial extent relative to respective said connection pins.

20. A clutch disk arrangement as in claim 17 wherein said axial retaining elements limit axial displacement of said support members.

21. A clutch disk arrangement as in claim 17 wherein said axial retaining elements are compressible.

22. A clutch disk arrangement as in claim 17 wherein said axial retaining elements secure said connection pins circumferentially.

23. A clutch disk arrangement as in claim 17 wherein said axial retaining elements secure said connection pins radially.

24. A clutch disk arrangement as in claim 7 wherein said connection pins have end portions which limit axial movement of one of said support members relative to said connection pins.

25. A clutch disk as in claim 24 wherein said end portions are formed as a wider diameter portion of said pins.
